(19) United States
(12) Patent Application Publication
(10) Pub. No.: US 2026/0335951 A1
(43) Pub. Date: Oct. 29, 2026

(54) PROCESSES FOR REDUCING ENVIRONMENTAL AVAILABILITY OF ENVIRONMENTAL POLLUTANTS

(71) Applicant: Albemarle Corporation, Charlotte, NC (US)

(72) Inventors: Zhaorong ZHANG, Baton Rouge, LA (US); Kim Sehye PINGREE, Baton Rouge, LA (US); Jon E. Miller, Baton Rouge, LA (US); Zhongxin GE, Baton Rouge, LA (US)

(73) Assignee: Albemarle Corporation, Charlotte, NC (US)

(21) Appl. No.: 19/120,529

(22) PCT Filed: Oct. 25, 2023
(86) PCT No.: PCT/US2023/035883

§ 371 Date: Apr. 11, 2025

Related U.S. Application Data
(60) Provisional application No. 63/419,524, filed on Oct. 26, 2022.

(51) Int. Cl. B09B 3/10; B01J 20/20; B09B 3/70; B09B 101/90; B09C 1/08

(52) U.S. Cl. CPC B09B 3/10; B01J 20/20; B09B 3/70; B09C 1/08; B09B 2101/90; B09C 2101/00

(57) ABSTRACT

This invention provides processes for reducing the environmental availability of one or more environmental pollutants in solids, liquids, and combinations of solids and liquids.

### TECHNICAL FIELD

This invention relates to remediation of environmental pollutants to reduce their environmental availability.

### BACKGROUND

Many pollutants are known be toxic to humans and to the environment. One of these known environmental pollutants, mercury, has been categorized as a priority hazardous substance by the Agency for Toxic Substances and Disease Registry (ATSDR) of the U.S. Health and Human Services Department. The U.S. National Priorities List (NPL), maintained by the U.S. Environmental Protection Agency (EPA), has listed numerous sites that were contaminated by mercury, such sites comprising various pollutant-containing substances, including solids (e.g., soil, debris, waste), liquids (e.g., groundwater, lakes, ponds), and combinations of solids and liquids (e.g., sludge, slurries, sediments). The majority of these sites have not been de-contaminated to remove mercury. Unacceptable levels of mercury or mercury compounds may also be present in sites not listed in the U.S. NPL. Environmental pollutants other than mercury raise similar concerns.

Mercury contamination can come from a variety of different sources such as mining and ore processes, metal smelting processes, chlor-alkali plants, mercury-based thermometer and thermostat production processes, fluorescent light production processes, and battery manufacturing processes. There also are many landfills contaminated with mercury-containing waste. Additionally, mercury pollutants are present in multiple forms including elemental mercury, organic mercury compounds, and inorganic mercury compounds, often at the same site. Different mercury forms and/or different substances often require different treating methods.

Mercury contaminated substances are likely to also comprise multiple other environmental pollutants. For example, some substances are also contaminated with organics and/or other heavy elements, and these other environmental pollutants provide similar challenges. Therefore, reducing the environmental availability of environmental pollutants at any particular site can be technically challenging and costly, depending on the substance that is contaminated, condition of the substance, waste types, mercury forms, and other contaminants or environmental pollutants present. Reducing the environmental availability of environmental pollutants, which in turn reduces the bioavailability of pollutants and thus their bioaccumulation, especially in substances such as soils, groundwaters, sediments, and slurries, is of particular interest.

Current commercial remediation processes applied to soils and other solids include stabilization/solidification, washing, thermal desorption, and vitrification. Processes applied to water and other liquids include precipitation/co-precipitation, adsorption, filtration, and bioremediation. Processes applied to sediments and other combinations of solids and liquids include in situ capping, dredging/excavation, a combination of these approaches, as well as Monitored Natural Recovery (MNR) and enhanced Monitored Natural Recovery (EMNR). Monitored natural recovery relies on natural processes to protect the environment and receptors from unacceptable exposures to contaminants, while enhanced MNR applies material or amendments to enhance natural recovery processes (such as the addition of a thin-layer cap or a reactive amendment such as carbon). These remediation technologies all provide benefits in controlling environmental impacts from environmental pollutants, including human health and ecological risks, but these remediation technologies also have limitations.

Another factor to be considered for some remediation technologies is the tendency for an environmental pollutant to migrate from (or leach out of) its location after it has been sequestered or stabilized. The U.S. EPA regulates this as well, and has a Toxicity Characteristic Leaching Procedure (TCLP), a test designed to determine the mobility of both organic and inorganic analytes present in liquid, solid, and multiphasic wastes.

Complicated bench- and pilot-scale research and screening tests have to be conducted to evaluate a technology to determine if it is suitable before it is selected to remediate an actual contaminated site. In addition, the variability with each site to be treated makes the remediation of mercury and other environmental pollutants contamination quite expensive and time-consuming. Thus, there is a need for new and more commercially attractive processes for reducing environmental availability and bioavailability of environmental pollutants in solids and liquids, as well as in combinations thereof.

### SUMMARY OF THE INVENTION

This invention provides processes for reducing environmental availability of at least a portion of one or more environmental pollutants in a substance comprising one or more environmental pollutants. A benefit provided by the processes of this invention is a reduction of environmental availability of toxic environmental pollutants in substances. Such toxic pollutants include mercury and methyl mercury, as well as heavy elements, and ecologically toxic organic matter. Heavy elements are often referred to as heavy metals, and heavy elements that can have their environmental availability reduced by the practice of this invention include mercury, chromium, arsenic, and selenium.

An advantage provided by the processes of this invention is that by reducing environmental availability of environmental pollutants in substances, bioavailability and bioaccumulation of such pollutants is also reduced. When the environmental pollutant is mercury, another advantage is that the processes of the invention do not need sulfide to be present, and so reduction of environmental availability and thus reduction of bioavailability is not negatively affected by acidic conditions which permit sulfides to form hydrosulfide, sulfuric acid, or sulfate compounds; this absence of the sulfur-containing composition in turn minimizes mercury methylation.

Processes of this invention can be used as the sole process for reducing the environmental availability and/or the presence of environmental pollutants, such as mercury, in a substance, or can be used to complement and/or enhance the reduction in environmental availability and/or the amount of such environmental pollutants in the substance than is attained by existing technologies.

An embodiment of this invention is a process for reducing environmental availability of at least a portion of one or more environmental pollutants in a substance comprising one or more environmental pollutants. This process comprises adding and/or applying a halogen-containing sorbent and an oxidant capable of oxidizing elemental mercury to the substance. In the halogen-containing sorbent, the halogen comprises one or more halogens selected from chlorine, bromine, and/or iodine and one or more substrate materials. Adding and/or applying the halogen-containing sorbent and an oxidant to the pollutant-containing substance reduces the environmental availability of at least a portion of one or more environmental pollutants in the substance.

These and other embodiments and features of this invention will be still further apparent from the ensuing description and appended claims.

### FURTHER DETAILED DESCRIPTION OF THE INVENTION

The present invention provides processes for reducing the environmental availability of environmental pollutants. As used throughout this document, the term “reducing environmental availability” refers to stabilizing, immobilizing, fixing, encapsulating, isolating, containing, destroying, detoxifying, decomposing, and decaying, reducing the amount of, reducing the mobility of, and/or reducing the migration ability of, at least one environmental pollutant. The stabilizing and/or immobilizing can be in a medium. Reducing the environmental availability of environmental pollutants in turn reduces the bioavailability of pollutants and thus their bioaccumulation.

As used herein, the terms “environmental pollutant” and “environmental pollutants” means a chemical element or compound or mixture thereof known be harmful humans and/or to impact the environment (ecosystem). Environmental pollutants are typically regulated by one or more government agencies. Examples of environmental pollutants include mercury in all of its forms, e.g., elemental mercury (metallic mercury), organic mercury compounds, and inorganic mercury compounds; other organic matter (including, for example, without limitation, hydrophobic organic compounds, polycyclic aromatic hydrocarbons, polyfluoroalkyl substances, perfluoroalkyl substances, polychlorinated biphenyls, dioxins, furans, and/or chlorinated pesticides); hazardous elements, organic and inorganic heavy element compounds (including, for example, without limitation, compounds comprising As, Pb, Zn, Cu, Cr, Ni, and/or Cd); and other environmental pollutants known to those skilled in the art.

As used throughout this document, terms such as “treated”, “contacted”, and “remediated” indicate that the halogen-containing sorbent interacts with the substance containing one or more environmental pollutants in a manner that results in the reduction of environmental availability of one or more environmental pollutants.

The remediation agents in the practice of this invention are halogen-containing sorbents and oxidants. The halogen-containing sorbents are sometimes referred to herein as “halogenated sorbents”. Halogen-containing sorbents are typically formed from one or more halogen-containing compounds and one or more substrate materials. Many substrate materials, especially activated carbons, are available or obtainable in a wide range of particle sizes, from nanometer to centimeter.

Substrate materials include carbonaceous materials and inorganic materials. Suitable carbonaceous materials that can be used as sorbents in the practice of this invention include, for example, without limitation, activated carbon, carbon black, char, and coke. A preferred carbonaceous material is activated carbon, which can be used in many forms including, for example, without limitation, powdered, granular, microspherical, pelleted, or extruded; and high specific surface area.

Suitable inorganic materials include inorganic oxides such as alumina (amorphous and crystalline), silica, magnesia and titania; natural zeolites such as chabazite, clinoptilolite, and faujasite; synthetic zeolites such as synthetic chabazite, zeolites with high Si:Al ratios (such as ZSM-5, beta zeolites), zeolites with moderate Si:Al ratios (such as Y zeolites, mordenite), zeolites with low Si:Al ratio (such as A zeolites, X zeolites), silica alumina phosphate (SAPO) zeolites, ion exchanged zeolites, uncalcined zeolites with or without organic structure directing agents, aluminosilicates with ordered pore structures (such as MCM-41, MCM-48, SBA-15, HMS, MSU-X), clay minerals such as kaolin, kaolinite, bentonite, and montmorillonite; synthetic clays such as laponite, saponite, sauconite, stevensite, kaolinite, and hectorite; organo-clays such as montmorillonite that has been treated with a trimethyl stearyl ammonium salt, a dimethyl dialkyl (C₁₄-C₁₈) ammonium salt, a methyl dihydroxy ethyl ammonium salt and a hydrogenated tallow ammonium salt, and aminopropyltriethoxysilane and octadecylamine; bentonite, hectorite, and attapulgite that have been treated with a quaternary ammonium salt; and zeolites that have been treated with N,N,N-trimethyl-l-hexadecanaminium chloride; inorganic hydroxides such as iron hydroxide; mixed metal oxides such as hydrotalcites and metallated double layered clays; diatomaceous earth; cement dust; hydroprocessing catalysts including those on substrates comprising alumina, silica, and/or titania, inorganic carbonates, such as alkali metal carbonates (e.g., sodium carbonate and potassium carbonate) and alkaline earth carbonates (e.g., calcium carbonate); and mixtures of any two or more of the foregoing. Preferred inorganic materials include inorganic oxides, especially silica, natural zeolites, especially chabazite, and clay minerals, especially kaolinite and bentonite; CaCO₃ is also a preferred substrate material.

The halogen element in the halogen-containing sorbent can be chlorine, bromine, iodine, or a mixture of any two or more of these halogens. Bromine and iodine are preferred halogens; bromine is a more preferred halogen. Suitable halogen-containing substances for forming a halogen-containing sorbent include, for example, without limitation, elemental iodine and/or iodine compounds, elemental bromine and/or bromine compounds, elemental chlorine and/or chlorine compounds, and other suitable halogen compounds, as will be known to those skilled in the art. Halogen-containing substances that can be used include elemental halogens, hydrohalic acids, alkali metal halides, alkaline earth halides, and ammonium halides. Mixtures of any two or more halogen-containing substances can be used; the mixtures may contain the same or different halogens.

Hydrohalic acids include hydrogen chloride, hydrogen bromide, and hydrogen iodide. Bromides and iodides are preferred halides; more preferred are bromides. Alkali metal halides include lithium halides, sodium halides, potassium halides, rubidium halides, and cesium halides; sodium halides and potassium halides are preferred. Preferred alkali metal halides include sodium chloride, sodium bromide, sodium iodide, potassium chloride, potassium bromide, and potassium iodide; more preferred are sodium bromide, potassium bromide, and potassium iodide. Alkaline earth halides include magnesium halides, calcium halides, strontium halides, and barium halides; magnesium halides and calcium halides are preferred. Preferred alkaline earth halides include magnesium chloride, magnesium bromide, magnesium iodide, calcium chloride, calcium bromide, and calcium iodide; more preferred are magnesium bromide and calcium bromide. Ammonium halides include ammonium chloride, ammonium bromide, and ammonium iodide; a preferred ammonium halide is ammonium bromide. More preferred halogen-containing substances include elemental bromine, hydrogen bromide, sodium bromide, potassium bromide, and calcium bromide, especially sodium bromide.

Halogen-containing sorbents can be made from a substrate material and one or more halogen-containing substances, especially for bromine-containing sorbents, as described in U.S. Pat. Nos. 6,953,494 and 9,101,907, and in International Patent Pub. No. WO 2012/071206. In some embodiments, preferred halogen-containing sorbents are bromine-containing sorbents. In some embodiments, preferred halogen-containing sorbents are halogen-containing activated carbons. In other embodiments, preferred halogen-containing activated carbons are chlorine-containing activated carbons, bromine-containing activated carbons, and iodine-containing activated carbons. In preferred embodiments, the halogen-containing sorbents are iodine-containing activated carbons and bromine-containing activated carbons. In more preferred embodiments, the halogen-containing sorbents are bromine-containing activated carbons. Bromine-containing activated carbons are available commercially from Albemarle Corporation.

In other embodiments, preferred halogen-containing sorbents are chlorine-containing activated carbons and iodine-containing activated carbons. In still other embodiments, preferred halogen-containing sorbents are halogen-containing chabazites, halogen-containing bentonites, halogen-containing kaolinites, and halogen-containing silicas; more preferred halogen-containing sorbents are iodine-containing chabazites, bromine-containing chabazites, iodine-containing g bentonites, bromine-containing bentonites, iodine-containing kaolinites, bromine-containing kaolinites, iodine-containing silicas, and bromine-containing silicas; still more preferred are bromine-containing silica, bromine-containing kaolinite, and bromine-containing bentonites.

In another embodiment, preferred halogen-containing sorbents include bromine-containing silica, bromine-containing kaolinite, and bromine-containing bentonite.

The amount of halogen (or halogen content) on the substrate material is typically equivalent to a total bromine content (or calculated as bromine) in the range of about 0.1 wt % to about 50 wt %, preferably equivalent to a total bromine content in the range of about 0.25 wt % to about 40 wt %, more preferably about 0.5 wt % to about 35 wt %, even more preferably about 1 wt % to about 20 wt %, and still more preferably about 2 wt % to about 12 wt %, based on the total weight of the halogen-containing sorbent.

As used throughout this document, the phrases “as bromine,” “reported as bromine,” “calculated as bromine” and analogous phrases for the halogens refer to the amount of halogen, where the numerical value is calculated for bromine, unless otherwise noted. For example, chlorine may be used, but the amount of halogen in the halogen-containing sorbent is stated as the value for bromine.

Halogen-containing activated carbons suitable for use in processes of this invention can have a wide range of particle sizes and distributions, from nanometer to centimeter; and can be formed from activated carbon forms including, for example, without limitation, powdered, granular, microspherical, pelleted, or extruded; high specific surface area, a variety of unique pore structures; and other features as will be familiar to those skilled in the art.

Halogen-containing sorbents, especially halogen-containing carbonaceous sorbents, especially iodine-containing and bromine-containing sorbents, more especially bromine-containing carbonaceous sorbents, can reduce environmental availability of pollutants in substances through means including, for example, without limitation, oxidation and/or adsorption. Adsorption can reduce the environmental availability of environmental pollutants by reducing mobility of such pollutants. Other ways in which halogen-containing sorbents can reduce environmental availability of pollutants are by enhancing the degradation of such pollutants through surface reactions; and/or by inhibiting the formation of pollutants such as methyl mercury; and/or by other mechanisms. In the processes of this invention, whether applied to solids, or liquids, or combinations thereof, the environmental pollutants adsorbed by halogen-containing sorbents are stabilized such that desorption into the environment is substantially minimized.

Oxidants that are suitable for use in the practice of this invention are compounds that are capable of oxidizing elemental mercury. These oxidants are usually capable of oxidizing other heavy elements, including chromium, arsenic, and selenium. In the practice of this invention, these oxidants are inorganic oxidants and organic oxidants. The inorganic oxidants are typically salts. The organic oxidants are preferably organic peroxides and halogenated hydantoins.

Inorganic salts that are suitable oxidants in the practice of this invention include persulfate salts, permanganate salts, hypochlorite salts, hypobromite salts, chlorite salts, chlorate salts, bromate salts, and perchlorate salts; preferably permanganate salts, hypochlorite salts, and chlorate salts. Preferably, these salts are their alkali metal salts, alkaline earth metal salts, and/or ammonium salts; more preferably, the salts are alkali metal salts.

Suitable inorganic salts for use as oxidants in the practice of this invention include ammonium persulfate, sodium persulfate, potassium persulfate, sodium permanganate, potassium permanganate, ammonium hypochlorite, sodium hypochlorite potassium hypochlorite, magnesium hypochlorite, calcium hypochlorite, ammonium hypobromite, sodium hypobromite, potassium hypobromite, calcium hypobromite, ammonium chlorite, sodium chlorite, potassium chlorite, calcium chlorite, ammonium chlorate, sodium chlorate, potassium chlorate, ammonium bromate, sodium bromate, potassium bromate, ammonium perchlorate, sodium perchlorate, and potassium perchlorate.

Preferred inorganic oxidants include alkali metal permanganates, alkali metal hypochlorites, and alkaline earth metal chlorates. More preferred inorganic oxidants are sodium permanganate, potassium permanganate, sodium hypochlorite, potassium hypochlorite, magnesium chlorate, and calcium chlorate. Even more preferred inorganic oxidants are potassium permanganate, sodium hypochlorite, and calcium chlorate.

The organic oxidants that are organic peroxides have hydrocarbyl groups that contain four to about twelve, preferably four to about ten, carbon atoms in each group; the hydrocarbyl groups can be the same or different, and can be alkyl (straight-chain, branched, or cyclic), aryl, or ar-alkyl. Preferred hydrocarbyl groups are branched alkyl groups and ar-alkyl groups. Suitable hydrocarbyl groups include tert-butyl, 1,1-dimethylpropyl, 1,1-dimethylbenzyl, and 1,1-dimethyl-4-methylphenyl; preferably tert-butyl and 1,1-dimethylpropyl. Suitable organic peroxides include di-tert-butylperoxide, bis(1,1-dimethylpropyl) peroxide, tert-butyl 1,1-dimethylbenzyl peroxide, tert-butyl 1,1-dimethyl-4-methylphenyl peroxide, and bis(1,1-dimethylbenzyl) peroxide. Preferred organic peroxides include di-tert-butylperoxide.

The organic oxidants that are halogenated hydantoins are halogenated 5-hydrocarbyl hydantoins and halogenated 5,5-dihydrocarbyl hydantoins which are 1,3-dibromo-, 1,3-dichloro-, and/or N,N′-bromochloro-(or 1,3-bromochloro) derivatives of 5-hydrocarbyl hydantoins and 5,5-dihydrocarbyl hydantoins. Halogenated 5,5-dihydrocarbyl hydantoins are preferred. More preferred halogenated hydantoins are halogenated 5-alkyl and halogenated 5,5-dialkyl hydantoins, especially those in which each alkyl group contains up to about 6 carbon atoms. Still more preferred are halogenated 5,5-dialkyl hydantoins in which each alkyl group contains, independently, up to 3 carbon atoms. Especially preferred are halogenated 5,5-dimethylhydantoins.

Suitable hydantoins include 5-methyl hydantoin, 5-ethyl hydantoin, 5-(1-propyl) hydantoin, 5-(2-propyl) hydantoin, 5-(2-methylpropyl) hydantoin,5-(2-butyl) hydantoin, 5-phenyl hydantoin, 5-ethyl-5-methyl hydantoin, 5-ethyl-5-methyl hydantoin, 5-methyl-5-(2-methylpropyl) hydantoin, 5-ethyl-5-(2-methylpropyl) hydantoin, 5-methyl-5-phenyl hydantoin, 5-ethyl-5-phenyl hydantoin, 5-benzyl-5-methylhydantoin, 5,5-dimethylhydantoin, and 5,5-diethylhydantoin; preferred are 5,5-dimethylhydantoin, and 5,5-diethylhydantoin, especially 5,5-dimethylhydantoin.

Preferred halogenated hydantoins 1,3-chloro-5,5-dimethylhydantoin, 1,3-bromochloro-5,5-dimethylhydantoin and 1,3-dibromo-5,5-dimethylhydantoin; more preferred are 1,3-bromochloro-5,5-dimethylhydantoin and 1,3-dibromo-5,5-dimethylhydantoin, especially 1,3-dibromo-5,5-dimethylhydantoin.

Mixtures of any two or more oxidants can be used, including mixtures containing two or more inorganic oxidants, mixtures containing two or more organic oxidants, and mixtures of one or more inorganic oxidants and one or more organic oxidants. Preferably, the oxidant is one or inorganic oxidants.

The oxidant and the halogen-containing sorbent are typically used in amounts by weight of about 1:1 to about 1:25, preferably about 1:2 to about 1:20, more preferably about 1:3 to about 1:15, even more preferably about 1:3 to about 1:10 oxidant:halogen-containing sorbent. The preferred amount of oxidant may vary with the amount of elemental mercury present in the substance being treated.

Mercury and other environmental pollutants are adsorbed onto or removed by halogen-containing sorbents, especially halogen-containing activated carbons, more especially iodine-containing and bromine-containing sorbents, more especially bromine-containing carbonaceous sorbents, still more especially bromine-containing activated carbon. Different halogen (especially bromine) species can be formed on a halogen-containing sorbents, especially bromine-containing sorbents, particularly bromine-containing activated carbon. For example, bromine, a bromine species, can oxidize elemental mercury and form mercuric bromide which can be adsorbed into pores of activated carbon; another species, bromide ion, can chemically bond with ionic mercury for adsorption onto the surface of activated carbon; another component might catalyze mercury oxidation and enhance the stabilization or adsorption of the oxidized mercury product.

The oxidants used pursuant to this invention can oxidize elemental mercury, allowing the oxidized mercury to bond with halogen atoms on the sorbent and/or become absorbed into the pores of the substrate material of the halogen-containing sorbent.

Some halogen-containing sorbents, particularly halogen-containing activated carbons, especially iodine-containing and bromine-containing sorbents, more especially bromine-containing carbonaceous sorbents, particularly bromine-containing activated carbons, can physically and chemically adsorb mercury of different oxidation states including elemental mercury, oxidized mercury, and organic mercury. Mercury adsorbed on halogen-containing activated carbon, especially bromine-containing activated carbon, is stable in a wide range of pH values, where “stable” means that the mercury does not separate from the sorbent in appreciable amounts after adsorption.

The halogen-containing sorbents and oxidants used in processes of this invention can be combined with other optional components such as pH buffers (including, for example, without limitation, ammonium carbonates, metal carbonates, ammonium phosphates, and metal phosphates); carriers (including, for example, without limitation, sand and mud); binders (including, for example, without limitation, mud, clay, and polymers); and/or other additives (including, for example, without limitation, iron compounds and sulfur compounds).

In the practice of this invention, the halogen-containing sorbent and the oxidant can be used in various forms, including as dry solids or in combination with a suitable fluid, for example, in a slurry. As used herein, the term “suitable fluid” means fluids such as water, and other fluids. Those skilled in the art, given the teachings of this disclosure, have at hand the knowledge to select a suitable fluid, as the selection depends upon variables such as the composition of the substance, the composition of the environmental pollutants present in the substance, and the like.

Blends comprising a halogen-containing sorbent and an oxidant capable of oxidizing elemental mercury are compositions of this invention, and are formed by processes comprising combining the substrate material, halogen-containing compound(s), and oxidant(s) in any order. When the mixing is sequential, the substrate material is preferably combined with the halogen-containing compound(s) to form the halogen-containing sorbent, which is then combined with the oxidant(s). Dry blending of the ingredients is a convenient method for combining the ingredients. In some embodiments in which the halogen-containing compound is a salt, such as an alkali metal halide, the halogen-containing compound can be combined with the sorbent by an incipient wetness technique; the halogen-containing sorbent can be dried prior to contact with the oxidant(s). The substrate materials, halogen, halogen-containing compounds, oxidants, amounts thereof, and preferences therefor, are as described above.

Some treatments of substances can be conducted both in situ and ex situ. Here, “in situ” refers to treatment that occurs without moving the substance from its location. Examples of in situ treatments include injecting the halogen-containing sorbent into the soil (usually as a slurry) or mechanically mixing the halogen-containing sorbent with the soil. Analogously, “ex situ” refers to treatment that occurs during or after removal of the substance from its location; after treatment, the substance may or may not be returned to the location.

Thermal desorption and retorting are two common ex situ methods of thermal treatment for mercury remediation. The technology heats contaminated medium to volatilize mercury, followed by condensing vapors into liquid elemental mercury. A halogen-containing sorbent and oxidant may be used to adsorb mercury as a replacement of the liquid mercury condenser or to remove mercury in off-gasses exiting the condenser.

In some applications, the halogen-containing sorbent and the oxidant will remain in or with the substance. In other applications, the sorbent and any remaining oxidant may be collected after use. When the halogen-containing sorbent is collected after use, the sorbent can be disposed of, or regenerated and re-used.

The substances containing one or more environmental pollutants are solids, liquids, or combinations of a solid and a liquid, or combinations of one or more solids and one or more liquids. When the substance is a solid, it may comprise more than one solid. When the substance is a liquid, it may comprise more than one liquid.

In some processes of this invention, whether applied to a substance comprising one or more solids, one or more liquids, or combinations of at least one solid and at least one liquid, use of the halogen-containing sorbent and an oxidant can be a stand-alone remedial approach or can complement the use of other remediation methods. In other processes according to the invention, the halogen-containing sorbent and an oxidant can be used in addition to one or more other remediation agents in the same remediation procedure.

Adding a halogen-containing sorbent and an oxidant into contaminated waste adsorbs one or more pollutants. In some embodiments, the halogen-containing sorbent and the oxidant remain in the substance to stabilize and/or solidify the substance. In other embodiments, the combined halogen-containing sorbent, oxidant, and substance are placed in landfill, often with a binder and other compounds.

As used herein, the term “solid” and/or “solids”, include without limitation, soil, debris, waste and other such substances known to those skilled in the art. Soil is a preferred solid to treat in the practice of this invention.

Processes of the invention are provided for reducing environmental availability of at least a portion of one or more environmental pollutants in a solid comprising one or more environmental pollutants. Substances which are solids are sometimes referred to herein as solid substances.

The adding and/or applying of the halogen-containing sorbent and an oxidant to the solid can comprise:
(a) injecting halogen-containing sorbent and an oxidant into the solid, optionally through holes and/or wells and/or channels that are present in the substance, whether already present or manually created, e.g., by drilling into the substance; and/or
(b) applying the halogen-containing sorbent and an oxidant to a surface of the solid; and/or
(c) combining the halogen-containing sorbent and an oxidant with at least a portion of a surface of the solid; and/or
(d) placing the halogen-containing sorbent and an oxidant in a vacuum well in which the solid is treated; and/or
(e) adding the halogen-containing sorbent and an oxidant to a contained solid; and/or
(f) combining the halogen-containing sorbent and an oxidant with the solid; and/or
(g) adding the halogen-containing sorbent and an oxidant to a reactive barrier; and/or
(h) forming a reactive barrier containing the halogen-containing sorbent and an oxidant.

Combining the halogen-containing sorbent and an oxidant with the surface of the solid as in (c) above can be done by combining the halogen-containing sorbent and the oxidant with a portion of the solid, and then applying the combination of sorbent, oxidant, and solid to the surface of the solid, or by combining the halogen-containing sorbent and the oxidant with the surface of the solid.

Some preferred methods for adding and/or applying the halogen-containing sorbent and an oxidant to the solid are:
(a) injecting a halogen-containing sorbent and an oxidant into the solid;
(b) applying a halogen-containing sorbent and an oxidant to a surface of the solid; and/or
(c) combining a halogen-containing sorbent and an oxidant with at least a portion of a surface of the solid.

An embodiment of treatment of solids to reduce environmental availability of one or more environmental pollutants involves (i) drilling holes, wells, and/or channels into the solid, (ii) covering a surface of the solid with a layer of halogen-containing sorbent and an oxidant, and (iii) heating some parts of the solid to migrate one or more environmental pollutants, e.g., mercury, toward the surface which has halogen-containing sorbent and oxidant thereon.

Another embodiment of treatment of solids to reduce environmental availability of one or more environmental pollutants involves (i) drilling holes, wells, and/or channels into the solid, (ii) filling some holes or channels with halogen-containing sorbent and oxidant, and (iii) purging heated air into holes or channels to migrate one or more environmental pollutants, e.g., mercury, toward the holes filled with halogen-containing sorbent and oxidant.

In some embodiments of the invention, the solid is heated to vaporize the environmental pollutant, e.g., mercury, in a vacuum well; when a halogen-containing sorbent and an oxidant are present in the vacuum well as in (d) above, the halogen-containing sorbent and oxidant together can absorb the vaporized environmental pollutant(s). In these procedures, the halogen-containing sorbent and the oxidant are placed in the vacuum well in contact with the vapor produced in the vacuum well at one or more locations before the vapor exits to atmosphere. One application of this procedure is for Soil Vapor Extraction (SVE) for mercury remediation, and halogen-containing sorbents, especially bromine-containing activated carbons, along with an oxidant, can be placed in the vacuum well to adsorb mercury.

In a particular type of solid substance, soil, halogen-containing sorbents and oxidants can be utilized to immobilize mercury prior to, or during, stabilization and solidification (S/S) of soil in situ and/or ex situ treatment. One ex situ process adds halogen-containing sorbent, oxidant, one or more binders, and other components into a contaminated substance and mixes them together in a reactor. The mixture is then stabilized and cemented or placed in landfill. In some embodiments, bromine-containing powdered activated carbon can be used with the oxidant in S/S treatment processes. Mercury adsorbed by bromine-containing powdered activated carbon is stable during making and curing of concrete. This is advantageous because fly ash and cement are typical binders used in S/S technologies.

In another embodiment of this invention in which halogen-containing sorbents, especially bromine-containing powdered activated carbons, along with an oxidant, are remediation agents for mercury contaminated soil, the halogen-containing sorbent and the oxidant are spread on top of the contaminated soil. In this method the soil is not disturbed and the halogen-containing sorbent, especially a bromine-containing activated carbon, along with the oxidant, are present in the top layer of soil and block migration of mercury from the soil.

Halogen-containing sorbents, especially bromine-containing activated carbons, along with the oxidant, can be mixed with another agent to create a mixture that improves penetration of the halogen-containing sorbent into the solid, especially soil. The amount of halogen-containing sorbent added may be less than 10% of the top layer of soil, the amount of oxidant can be up to 10% of the top layer of soil, and the top layer of soil may be up to 10 cm thick. In some embodiments, a pH adjustment agent is also applied, either separately or in admixture with the halogen-containing sorbent and oxidant, optionally along with an agent that improves penetration of the halogen-containing sorbent and oxidant into the solid.

Processes of the invention are provided for reducing environmental availability of at least a portion of one or more environmental pollutants in a liquid comprising one or more environmental pollutants. As used herein, the term “liquid” and/or “liquids”, include without limitation, groundwater, wastewater, surface water, salt water, fresh water (e.g., lakes, ponds), and other such substances known to those skilled in the art. Substances which are liquids are sometimes referred to herein as liquid substances.

The adding and/or applying of the halogen-containing sorbent and the oxidant to the liquid can comprise:
(a) injecting the halogen-containing sorbent and an oxidant into the liquid; if desired, the used sorbent and any remaining oxidant can be filtered; and/or
(b) applying the halogen-containing sorbent and an oxidant to the surface of the liquid; and/or
(c) combining the halogen-containing sorbent and an oxidant with the liquid; and/or
(d) passing the liquid over a fixed bed comprising the halogen-containing sorbent and an oxidant; and/or
(e) passing the liquid through a filter comprising the halogen-containing sorbent and an oxidant; and/or
(f) pumping the liquid through a fixed bed or column containing the halogen-containing sorbent and an oxidant; and/or
(g) adding the halogen-containing sorbent and an oxidant to a contained volume of liquid.

Combining the halogen-containing sorbent and the oxidant with the liquid as in (c) above can be done by combining the halogen-containing sorbent and the oxidant with the bulk liquid, or by combining the halogen-containing sorbent and the oxidant with a portion of the liquid to form a slurry, and then combining the slurry with the remaining liquid.

Some substances are combinations of at least one solid and at least one liquid, and include sludge, slurries, sediments, pore water (e.g., soil pore water or sediment pore water) and other combinations of solids and liquids. Sediment, soil pore water, and sediment pore water are preferred combination substances to treat in the practice of this invention. These combinations are sometimes referred to as multiphasic substances. Processes of the invention are provided for reducing environmental availability of at least a portion of one or more environmental pollutants in a combination comprising one or more environmental pollutants. Substances which are combinations are sometimes referred to herein as combination substances.

The adding and/or applying of the halogen-containing sorbent and an oxidant to the combination can comprise adding and/or applying the halogen-containing sorbent and the oxidant to the combination. In such processes, adding and/or applying the halogen-containing sorbent and an oxidant to the combination can comprise:
(a) injecting the halogen-containing sorbent and an oxidant into the combination, optionally through holes and/or wells and/or channels that are present in the substance, whether already present or manually created, e.g., by drilling into the combination; and/or
(b) applying the halogen-containing sorbent and an oxidant to a surface of the combination; and/or
(c) combining the halogen-containing sorbent and an oxidant with at least a portion of a surface of the combination as described above for solid and/or liquid substances; and/or
(d) combining the halogen-containing sorbent and an oxidant with the combination; and/or
(e) placing the halogen-containing sorbent and an oxidant in a vacuum well in which the combination is treated, in a manner similar to that described for solid substances; and/or
(f) adding the halogen-containing sorbent and an oxidant to a contained combination; and/or
(g) covering a surface of the substance with a layer comprising the halogen-containing sorbent and an oxidant; and/or
(h) placing the halogen-containing sorbent and an oxidant into a cap; and/or
(i) adding the halogen-containing sorbent and an oxidant to a reactive barrier; and/or
(j) forming a reactive barrier containing the halogen-containing sorbent and an oxidant; and/or
(k) placing the halogen-containing sorbent and an oxidant within a geotextile mat.

Combining the halogen-containing sorbent and an oxidant with the combination as in (d) above can be done by combining the halogen-containing sorbent and the oxidant with the combination, or by combining the halogen-containing sorbent and the oxidant with a portion of the combination to form a mixture, and then combining the mixture with the surface of the combination. In these embodiments, the halogen-containing sorbent can comprise, for example, without limitation, a halogen-containing activated carbon sorbent, preferably a bromine-containing carbon sorbent, more preferably a bromine-containing activated carbon sorbent.

Some preferred methods for adding and/or applying the halogen-containing sorbent and an oxidant to the combination are:
(a) injecting a halogen-containing sorbent and an oxidant into the combination;
(b) applying a halogen-containing sorbent and an oxidant to a surface of the combination;
(c) combining a halogen-containing sorbent and an oxidant with at least a portion of a surface of the combination; and/or
(d) combining a halogen-containing sorbent and an oxidant with the combination.

As will be clear to those skilled in the art, depending upon the substance treated, numerous variables regarding use of this invention must be considered. In all of the processes of this invention, whether applied to solids, liquids, or combinations thereof, given the teachings herein, those skilled in the art have at hand the knowledge to determine amounts of halogen-containing sorbent to use; whether to use optional components in combination with the sorbent, and, if so, the specific optional components and amounts thereof that will be beneficial; the number of applications of processes of this invention, and the period of time between such applications, that will be beneficial; whether to use processes of this invention in combination with known remediation methods, and, if so, how to do so to obtain beneficial results, etc.

The following example is presented for purposes of illustration, and is not intended to impose limitations on the scope of this invention.

### EXAMPLE 1

Sorbents containing NaBr (NaBr-PAC) were formed by incipient wetness impregnation of NaBr in water onto powdered activated carbon (PAC; 10.24 g NaBr per 100 g PAC), followed by drying the mixture in an oven at 105 °C overnight, for a loading of 8 wt % bromine in the NaBr-PAC sorbent. Blends of NaBr-PAC and an oxidant were formed by dry mixing NaBr-PAC sorbents with different oxidants at weight ratios of NaBr-PAC:oxidant of 5:1.

A chloralkaline soil containing elemental mercury, organic mercury, and other pollutants was treated with various sorbents by dry mixing each sorbent with a portion of the soil. Each portion was mixed with water, and the water was extracted as the soil leachate; each soil leachate was sampled for analysis. The amount of mercury present in the leachate from the treated soil was determined in an atomic absorption spectrometer with a mercury vapor analyzer via cold vapor atomic absorption (CVAA; Atomic Absorption Mercury Spectrometer with Zeeman background correction, Ohio Lumex Co., model no. RA 915+). Results are summarized in Table 1.

TABLE 1

| | Amount | Amount | Hg in soil |
|---|---|---|---|
| Sorbent + oxidant | sorbent² | oxidant | leachate, μg/L³ |
| None¹ | 0 | 0 | 717 |
| PAC¹ | 5 wt % | 0 | 727 |
| Br-PAC^{1,4} | 5 wt % | 0 | BD⁵ |
| NaBr-PAC + Ca(ClO₃)₂ | 5 wt % | 1 wt % | BD⁵ |
| NaBr-PAC + KMnO₄ | 5 wt % | 1 wt % | BD⁵ |

¹Comparative example.
²Relative to the weight of soil treated.
³Average of two runs.
⁴Formed from elemental bromine and PAC.
⁵BD = below detection limit (1 μg/kg).

The results summarized in Table 1 show that the blend of NaBr-PAC and an oxidant provides the comparable performance to Br-PAC for reduction of leachable mercury after treatment.

Further embodiments of the invention include, without limitation:

A) A process for reducing environmental availability of at least a portion of one or more environmental pollutants in a substance comprising one or more environmental pollutants, which process comprises
adding and/or applying a halogen-containing sorbent and an oxidant capable of oxidizing elemental mercury to said substance, wherein the halogen-containing sorbent comprises one or more halogens selected from chlorine, bromine, and/or iodine, and one or more substrate materials,
thereby reducing environmental availability of at least a portion of one or more environmental pollutants in the substance.

B) The process as in A) wherein the halogen-containing sorbent comprises a substrate material selected from one or more carbonaceous materials, and/or wherein the halogen-containing sorbent comprises a substrate material selected from one or more inorganic materials.

C) The process as in B) wherein the carbonaceous material is activated carbon, and/or wherein the inorganic material is selected from inorganic oxides, natural zeolites, inorganic carbonates, and clay minerals.

D) The process as in B) or C) wherein the inorganic material is selected from chabazite, silica, kaolinite, and bentonite.

E) The process as in any one of A)-D) wherein the halogen-containing sorbent is a bromine-containing sorbent.

F) The process as in A) wherein the halogen-containing sorbent is a halogen-containing activated carbon sorbent.

G) The process as in A) wherein the halogen-containing sorbent is a bromine-containing activated carbon sorbent.

H) The process as in any one of A)-G) wherein the halogen-containing sorbent has a halogen content of about 0.1 wt % to about 50 wt % calculated as bromine and based on the total weight of the halogen-containing sorbent.

I) The process as in any one of A)-G) wherein the oxidant is an inorganic oxidant, and/or wherein the oxidant is an organic oxidant.

J) The process as in I) wherein
the inorganic oxidant is a permanganate salt, a hypochlorite salt, and/or a chlorate salt, and/or wherein the inorganic oxidant is an alkali metal salt, an alkaline earth metal salt, and/or an ammonium salt; and/or
wherein the organic oxidant is an organic peroxide or a halogenated hydantoin.

K) The process as in I) wherein
the inorganic oxidant is an alkali metal permanganate, an alkali metal hypochlorite, and/or an alkaline earth metal chlorate, and/or
when the oxidant is an organic peroxide, the organic peroxide has a branched alkyl group and/or an ar-alkyl group, and wherein when the oxidant is a halogenated hydantoin, the halogenated hydantoin is a halogenated 5,5-dihydrocarbyl hydantoin.
L) The process as in I) wherein
the inorganic oxidant is potassium permanganate, sodium hypochlorite, and/or calcium chlorate, and/or
the organic oxidant is selected from tert-butyl peroxide, 1,3-bromochloro-5,5-dimethylhydantoin, and 1,3-dibromo-5,5-dimethylhydantoin.

M) The process as in any one of A)-L) wherein the one or more environmental pollutants is mercury, chromium, arsenic, and/or selenium.

N)) The process as in any one of A)-M) wherein the substance comprising said environmental pollutants is a solid, and wherein adding and/or applying the halogen-containing sorbent and an oxidant to the solid comprises:
(a) injecting a halogen-containing sorbent and an oxidant into the solid;
(b) applying a halogen-containing sorbent and an oxidant to a surface of the solid;
(c) combining a halogen-containing sorbent and an oxidant with at least a portion of a surface of the solid;
(d) placing a halogen-containing sorbent and an oxidant in a vacuum well in which the solid is treated;
(e) adding a halogen-containing sorbent and an oxidant to a contained solid;
(f) combining a halogen-containing sorbent and an oxidant with the solid;
(g) adding a halogen-containing sorbent and an oxidant to a reactive barrier; and/or
(h) forming a reactive barrier containing a halogen-containing sorbent and an oxidant;
optionally wherein the solid is soil.

O) The process as in any one of A)-M) wherein the substance comprising said environmental pollutants is a liquid, and wherein adding and/or applying the halogen-containing sorbent and an oxidant to the liquid comprises:
(a) injecting a halogen-containing sorbent and an oxidant into the liquid;
(b) applying a halogen-containing sorbent and an oxidant to the surface of the liquid;
(c) combining a halogen-containing sorbent and an oxidant with the liquid;
(d) passing the liquid over a fixed bed comprising a halogen-containing sorbent and an oxidant;
(e) passing the liquid through a filter comprising a halogen-containing sorbent and an oxidant;
(f) pumping the liquid through a fixed bed or column containing a halogen-containing sorbent and an oxidant; and/or
(g) adding a halogen-containing sorbent and an oxidant to a contained volume of liquid.

P) The process as in any one of A)-M) wherein the substance comprising said environmental pollutants is a combination of at least one solid and at least one liquid, and wherein adding and/or applying the halogen-containing sorbent and an oxidant to the combination comprises:
(a) injecting a halogen-containing sorbent and an oxidant into the combination;
(b) applying a halogen-containing sorbent and an oxidant to a surface of the combination; (c) combining a halogen-containing sorbent and an oxidant with at least a portion of a surface of the combination;
(d) combining the halogen-containing sorbent and an oxidant with the combination;
(e) placing the halogen-containing sorbent and an oxidant in a vacuum well in which the combination is treated;
(f) adding the halogen-containing sorbent and an oxidant to a contained combination;
(g) covering a surface of the substance with a layer comprising a halogen-containing sorbent and an oxidant;
(h) placing a halogen-containing sorbent and an oxidant into a cap;
(i) adding a halogen-containing sorbent and an oxidant to a reactive barrier;
(j) forming a reactive barrier containing a halogen-containing sorbent and an oxidant; and/or
(k) placing a halogen-containing sorbent and an oxidant within a geotextile mat.

Q) The process as in P) wherein the adding and/or applying comprises:
(a) injecting a halogen-containing sorbent and an oxidant into the combination;
(b) applying a halogen-containing sorbent and an oxidant to a surface of the combination;
(c) combining a halogen-containing sorbent and an oxidant with at least a portion of a surface of the combination; and/or
(d) combining a halogen-containing sorbent and an oxidant with the combination; optionally wherein the combination is sediment.

R) The process as in Q) wherein the halogen-containing sorbent comprises a substrate material which is an activated carbon.

S) The process as in A) wherein the substance is soil or sediment, wherein the halogen-containing sorbent is a bromine-containing activated carbon sorbent, and wherein the oxidant is sodium hypochlorite, potassium bromate, or calcium chlorate.

T) The process as in Q) wherein
the oxidant is an inorganic oxidant and the inorganic oxidant is an alkali metal permanganate, an alkali metal hypochlorite, and/or an alkaline earth metal chlorate; and/or
the oxidant is an organic oxidant and when the organic oxidant is an organic peroxide, the organic peroxide has a branched alkyl group and/or an ar-alkyl group, and wherein when the oxidant is a halogenated hydantoin, the halogenated hydantoin is a halogenated 5,5-dihydrocarbyl hydantoin.

U) The process as in T wherein
the inorganic oxidant is potassium permanganate, sodium hypochlorite, and/or calcium chlorate; and/or
wherein the organic oxidant is selected from tert-butyl peroxide, 1,3-bromochloro-5,5-dimethylhydantoin, and 1,3-dibromo-5,5-dimethylhydantoin.

V) A blend of a halogen-containing sorbent and an oxidant capable of oxidizing elemental mercury, wherein the halogen-containing sorbent comprises one or more halogens selected from chlorine, bromine, and/or iodine.

W) The blend as in V wherein the halogen of the halogen-containing sorbent is bromine and/or iodine, wherein the halogen-containing sorbent comprises a substrate material selected from one or more carbonaceous materials, wherein when the oxidant is an inorganic oxidant, the oxidant is a permanganate salt, a hypochlorite salt, and/or a chlorate salt, and/or wherein the oxidant is an alkali metal salt, an alkaline earth metal salt, and/or an ammonium salt, and wherein when the oxidant is an organic oxidant, the oxidant is an organic peroxide or a halogenated hydantoin.

X) A process for forming a blend of a halogen-containing sorbent and an oxidant capable of oxidizing elemental mercury, which process comprises:
a) i) combining a halogen-containing compound and a substrate material to form a halogen-containing sorbent, and ii) combining the halogen-containing sorbent with an oxidant; or
b) combining a halogen-containing sorbent and an oxidant.

Y) The process as in X) wherein when the halogen of the halogen-containing sorbent is bromine, the substrate material is a carbonaceous material, wherein when the oxidant is an inorganic oxidant, the inorganic oxidant is a permanganate salt, a hypochlorite salt, and/or a chlorate salt, and/or wherein the inorganic oxidant is an alkali metal salt, an alkaline earth metal salt, and/or an ammonium salt, and wherein when the oxidant is an organic oxidant, the organic oxidant is an organic peroxide or a halogenated hydantoin.

Z) The process as in Y) wherein
the inorganic oxidant is an alkali metal permanganate, an alkali metal hypochlorite, and/or an alkaline earth metal chlorate; and/or
when the oxidant is an organic oxidant, when the organic oxidant is an organic peroxide, the organic peroxide has a branched alkyl group and/or an ar-alkyl group, and wherein when the organic oxidant is a halogenated hydantoin, the halogenated hydantoin is a halogenated 5,5-dihydrocarbyl hydantoin.

AA) The process as in Z) wherein
the inorganic oxidant is potassium permanganate, sodium hypochlorite, and/or calcium chlorate; and/or
the organic oxidant is selected from tert-butyl peroxide, 1,3-bromochloro-5,5-dimethylhydantoin, and 1,3-dibromo-5,5-dimethylhydantoin.

AB) The process as in any one of Y)-AA) wherein the substrate material is activated carbon.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A process for reducing environmental availability of at least a portion of one or more environmental pollutants in a substance comprising one or more environmental pollutants, which process comprises
adding and/or applying a halogen-containing sorbent and an oxidant capable of oxidizing elemental mercury to said substance, wherein the halogen-containing sorbent comprises one or more halogens selected from chlorine, bromine, and/or iodine, and one or more substrate materials,
thereby reducing environmental availability of at least a portion of one or more environmental pollutants in the substance.

2. The process according to claim 1 wherein the halogen-containing sorbent comprises a substrate material selected from one or more carbonaceous materials, and/or wherein the halogen-containing sorbent comprises a substrate material selected from one or more inorganic materials.

3. The process according to claim 2 wherein the carbonaceous material is activated carbon, and/or wherein the inorganic material is selected from inorganic oxides, natural zeolites, inorganic carbonates, and clay minerals.

4. The process according to claim 2 wherein the inorganic material is selected from chabazite, silica, kaolinite, and bentonite.

5. The process according to claim 1 wherein the halogen-containing sorbent is a bromine-containing sorbent.

6. The process according to claim 1 wherein the halogen-containing sorbent is a halogen-containing activated carbon sorbent.

7. The process according to claim 1 wherein the halogen-containing sorbent is a bromine-containing activated carbon sorbent.

8. The process according to claim 1 wherein the halogen-containing sorbent has a halogen content of about 0.1 wt % to about 50 wt % calculated as bromine and based on the total weight of the halogen-containing sorbent.

9. The process according to claim 1 wherein the oxidant is an inorganic oxidant, and/or wherein the oxidant is an organic oxidant.

10. The process according to claim 9 wherein
the inorganic oxidant is a permanganate salt, a hypochlorite salt, and/or a chlorate salt, and/or wherein the inorganic oxidant is an alkali metal salt, an alkaline earth metal salt, and/or an ammonium salt; and/or
wherein the organic oxidant is an organic peroxide or a halogenated hydantoin.

11. The process according to claim 9 wherein
the inorganic oxidant is an alkali metal permanganate, an alkali metal hypochlorite, and/or an alkaline earth metal chlorate, and/or
when the oxidant is an organic peroxide, the organic peroxide has a branched alkyl group and/or an ar-alkyl group, and wherein when the oxidant is a halogenated hydantoin, the halogenated hydantoin is a halogenated 5,5-dihydrocarbyl hydantoin.

12. The process according to claim 9 wherein
the inorganic oxidant is potassium permanganate, sodium hypochlorite, and/or calcium chlorate, and/or
the organic oxidant is selected from tert-butyl peroxide, 1,3-bromochloro-5,5-dimethylhydantoin, and 1,3-dibromo-5,5-dimethylhydantoin.

13. The process according to claim 1 wherein the one or more environmental pollutants is mercury, chromium, arsenic, and/or selenium.

14. The process according to claim 1 wherein the substance comprising said environmental pollutants is a solid, and wherein adding and/or applying the halogen-containing sorbent and an oxidant to the solid comprises:
(a) injecting a halogen-containing sorbent and an oxidant into the solid;
(b) applying a halogen-containing sorbent and an oxidant to a surface of the solid;
(c) combining a halogen-containing sorbent and an oxidant with at least a portion of a surface of the solid;
(d) placing a halogen-containing sorbent and an oxidant in a vacuum well in which the solid is treated;
(e) adding a halogen-containing sorbent and an oxidant to a contained solid;
(f) combining a halogen-containing sorbent and an oxidant with the solid;
(g) adding a halogen-containing sorbent and an oxidant to a reactive barrier; and/or
(h) forming a reactive barrier containing a halogen-containing sorbent and an oxidant; optionally wherein the solid is soil.

15. The process according to claim 1 wherein the substance comprising said environmental pollutants is a liquid, and wherein adding and/or applying the halogen-containing sorbent and an oxidant to the liquid comprises:
(a) injecting a halogen-containing sorbent and an oxidant into the liquid;
(b) applying a halogen-containing sorbent and an oxidant to the surface of the liquid;
(c) combining a halogen-containing sorbent and an oxidant with the liquid;
(d) passing the liquid over a fixed bed comprising a halogen-containing sorbent and an oxidant;
(e) passing the liquid through a filter comprising a halogen-containing sorbent and an oxidant;
(f) pumping the liquid through a fixed bed or column containing a halogen-containing sorbent and an oxidant; and/or
(g) adding a halogen-containing sorbent and an oxidant to a contained volume of liquid.

16. The process according to claim 1 wherein the substance comprising said environmental pollutants is a combination of at least one solid and at least one liquid, and wherein adding and/or applying the halogen-containing sorbent and an oxidant to the combination comprises:
(a) injecting a halogen-containing sorbent and an oxidant into the combination;
(b) applying a halogen-containing sorbent and an oxidant to a surface of the combination;
(c) combining a halogen-containing sorbent and an oxidant with at least a portion of a surface of the combination;
(d) combining the halogen-containing sorbent and an oxidant with the combination;
(e) placing the halogen-containing sorbent and an oxidant in a vacuum well in which the combination is treated;
(f) adding the halogen-containing sorbent and an oxidant to a contained combination;
(g) covering a surface of the substance with a layer comprising a halogen-containing sorbent and an oxidant;
(h) placing a halogen-containing sorbent and an oxidant into a cap;
(i) adding a halogen-containing sorbent and an oxidant to a reactive barrier;
(j) forming a reactive barrier containing a halogen-containing sorbent and an oxidant; and/or
(k) placing a halogen-containing sorbent and an oxidant within a geotextile mat.

17. The process according to claim 16 wherein the adding and/or applying comprises:
(a) injecting a halogen-containing sorbent and an oxidant into the combination;
(b) applying a halogen-containing sorbent and an oxidant to a surface of the combination;
(c) combining a halogen-containing sorbent and an oxidant with at least a portion of a surface of the combination; and/or
(d) combining a halogen-containing sorbent and an oxidant with the combination; optionally wherein the combination is sediment.

18. The process as in claim 17 wherein the halogen-containing sorbent comprises a substrate material which is an activated carbon.

19. The process according to claim 1 wherein the substance is soil or sediment, wherein the halogen-containing sorbent is a bromine-containing activated carbon sorbent, and wherein the oxidant is sodium hypochlorite, potassium bromate, or calcium chlorate.

20. The process according to claim 17 wherein
the oxidant is an inorganic oxidant and the inorganic oxidant is an alkali metal permanganate, an alkali metal hypochlorite, and/or an alkaline earth metal chlorate; and/or
the oxidant is an organic oxidant and when the organic oxidant is an organic peroxide, the organic peroxide has a branched alkyl group and/or an ar-alkyl group, and wherein when the oxidant is a halogenated hydantoin, the halogenated hydantoin is a halogenated 5,5-dihydrocarbyl hydantoin.

21. The process according to claim 20 wherein
the inorganic oxidant is potassium permanganate, sodium hypochlorite, and/or calcium chlorate; and/or
wherein the organic oxidant is selected from tert-butyl peroxide, 1,3-bromochloro-5,5-dimethylhydantoin, and 1,3-dibromo-5,5-dimethylhydantoin.

22. A blend of a halogen-containing sorbent and an oxidant capable of oxidizing elemental mercury, wherein the halogen-containing sorbent comprises one or more halogens selected from chlorine, bromine, and/or iodine.

23. The blend as in claim 22 wherein the halogen of the halogen-containing sorbent is bromine and/or iodine, wherein the halogen-containing sorbent comprises a substrate material selected from one or more carbonaceous materials, wherein when the oxidant is an inorganic oxidant, the oxidant is a permanganate salt, a hypochlorite salt, and/or a chlorate salt, and/or wherein the oxidant is an alkali metal salt, an alkaline earth metal salt, and/or an ammonium salt, and wherein when the oxidant is an organic oxidant, the oxidant is an organic peroxide or a halogenated hydantoin.

24. A process for forming a blend of a halogen-containing sorbent and an oxidant capable of oxidizing elemental mercury, which process comprises:
A) i) combining a halogen-containing compound and a substrate material to form a halogen-containing sorbent, and ii) combining the halogen-containing sorbent with an oxidant; or
B) combining a halogen-containing sorbent and an oxidant.

25. The process as in claim 24 wherein when the halogen of the halogen-containing sorbent is bromine, the substrate material is a carbonaceous material, wherein when the oxidant is an inorganic oxidant, the inorganic oxidant is a permanganate salt, a hypochlorite salt, and/or a chlorate salt, and/or wherein the inorganic oxidant is an alkali metal salt, an alkaline earth metal salt, and/or an ammonium salt, and wherein when the oxidant is an organic oxidant, the organic oxidant is an organic peroxide or a halogenated hydantoin.

26. The process according to claim 25 wherein
the inorganic oxidant is an alkali metal permanganate, an alkali metal hypochlorite, and/or an alkaline earth metal chlorate; and/or
when the oxidant is an organic oxidant, when the organic oxidant is an organic peroxide, the organic peroxide has a branched alkyl group and/or an ar-alkyl group, and wherein when the organic oxidant is a halogenated hydantoin, the halogenated hydantoin is a halogenated 5,5-dihydrocarbyl hydantoin.

27. The process according to claim 26 wherein
the inorganic oxidant is potassium permanganate, sodium hypochlorite, and/or calcium chlorate; and/or
the organic oxidant is selected from tert-butyl peroxide, 1,3-bromochloro-5,5-dimethylhydantoin, and 1,3-dibromo-5,5-dimethylhydantoin.

28. The process in claim 25 wherein the substrate material is activated carbon.
